(19) United States
(12) Patent Application Publication
(10) Pub. No.: US 2025/0202644 A1
(43) Pub. Date: Jun. 19, 2025

(54) ADAPTIVE PILOT PLACEMENT OF DISTRIBUTED-TONE RESOURCE UNITS

(71) Applicant: Cisco Technology, Inc., San Jose, CA (US)

(72) Inventors: Ardalan ALIZADEH, Campbell, CA (US); Sivadeep R. KALAVAKURU, Pleasanton, CA (US); Matthew A. SILVERMAN, Shaker Heights, OH (US); Peiman AMINI, Fremont, CA (US); Navid REYHANIAN, Fremont, CA (US)

(21) Appl. No.: 18/957,356

(22) Filed: Nov. 22, 2024

Related U.S. Application Data
(60) Provisional application No. 63/611,677, filed on Dec. 18, 2023.

(51) Int. Cl. H04L 5/00

(52) U.S. Cl. CPC H04L 5/0048; H04L 5/0007; H04L 5/0044

(57) ABSTRACT

Techniques and apparatus for mapping pilot tones to distributed-tone resource units (dRUs) are described. An example technique includes generating a pattern for mapping pilot tones to a plurality of orthogonal frequency division multiplexing (OFDM) symbols. Each of the plurality of OFDM symbols includes a respective one or more dRUs. The pilot tones are mapped to the plurality of OFDM symbols according to the pattern. The pattern allocates a different set of the pilot tones to the one or more dRUs within each of the plurality of OFDM symbols.

### CROSS-REFERENCE TO RELATED APPLICATIONS

This application claims benefit of co-pending U.S. Provisional Patent Application Ser. No. 63/611,677 filed Dec. 18, 2023. The aforementioned related patent application is herein incorporated by reference in its entirety.

### TECHNICAL FIELD

Embodiments presented in this disclosure generally relate to wireless communications. More specifically, embodiments disclosed herein relate to techniques for adaptive pilot placement of distributed-tone resource units (dRUs) in wireless communication systems.

### BACKGROUND

Certain wireless systems (e.g., Institute of Electrical and Electronics Engineers (IEEE) 802.11bn also known as ultra high reliability (UHR)) may support distributed-tone resource units (RUs) (dRUs). dRUs may overcome the power spectral density (PSD) limitations in wireless systems by placing tones in 1 megahertz (MHZ) distances to increase the spectrum efficiency, extend the communication range, or a combination thereof. As such, dRUs may allow for enhanced transmit powers compared to wireless systems that do not support dRUs. Additionally, dRUs may allow for a larger spectrum diversity by distributing the subcarriers over the entire frequency band.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 is a block diagram illustrating at least a portion of a transmitter and receiver, according to certain embodiments.

FIG. 3 illustrates an example pilot mapping tool of the transmitted illustrated in FIG. 2, according to certain embodiments.

FIG. 4 illustrates an example distributed mapping of pilot tones to distributed-tone resource units (dRUs), according to certain embodiments.

FIG. 5 is a flowchart of a method for mapping pilot tones to dRUs, according to certain embodiments.

FIG. 6 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a method for wireless communications performed by a computing device. The method includes generating a pattern for mapping pilot tones to a plurality of orthogonal frequency division multiplexing (OFDM) symbols, each of the plurality of OFDM symbols comprising a respective one or more distributed-tone resource units (dRUs). The method also includes mapping the pilot tones to the plurality of OFDM symbols according to the pattern, wherein the pattern allocates a different set of the pilot tones to the one or more dRUs within each of the plurality of OFDM symbols.

Another embodiment described herein is a computing device. The computing device includes one or more memories collectively storing instructions. The computing device also includes one or more processors communicatively coupled to the one or more memories. The one or more processors are individually or collectively configured to execute the instructions to cause the computing device to perform an operation. The operation includes generating a pattern for mapping pilot tones to a plurality of orthogonal frequency division multiplexing (OFDM) symbols, each of the plurality of OFDM symbols comprising a respective one or more distributed-tone resource units (dRUs). The operation also includes mapping the pilot tones to the plurality of OFDM symbols according to the pattern, wherein the pattern allocates a different set of the pilot tones to the one or more dRUs within each of the plurality of OFDM symbols.

Another embodiment described herein is a non-transitory computer-readable medium. The non-transitory computer-readable medium includes computer-executable code, which when executed by one or more processors of a computing device perform an operation. The operation includes generating a pattern for mapping pilot tones to a plurality of orthogonal frequency division multiplexing (OFDM) symbols, each of the plurality of OFDM symbols comprising a respective one or more distributed-tone resource units (dRUs). The operation also includes mapping the pilot tones to the plurality of OFDM symbols according to the pattern, wherein the pattern allocates a different set of the pilot tones to the one or more dRUs within each of the plurality of OFDM symbols.

### EXAMPLE EMBODIMENTS

In wireless systems that support dRUs, there may be challenges associated with channel estimation and carrier frequency offset (CFO) tracking. For example, compared to regular resource units (RUs) (rRUs) (e.g., RUs with contiguous tones), conventional pilot tones in dRU are sparsely and irregularly placed across the frequency band. This non-uniform distribution poses difficulties in both the initial channel estimation and subsequent tracking during payload decoding. While rRUs allow for more consistent and predictable channel state information (CSI) interpolation due to a denser pilot distribution, dRUs, with their far-apart pilot tones, often perform interpolation highly inaccurate or nearly impossible. These challenges, when unaddressed, can significantly impair the reliability and efficiency of dRU-based communications, especially in dynamic environments with varying channel conditions.

Certain embodiments described herein provide improved techniques for mapping pilot tones to dRUs. In certain embodiments, rather than using a fixed pilot distribution, a wireless device may distribute pilot tones across both time and frequency. The techniques described herein for mapping pilot tones to dRUs may provide various technical advantages. For example, the distributed mapping of pilot tones across time and frequency described herein may minimize (or at least reduce) the effects of deep fades or nulls in the frequency response since different tones may not consistently fall into the same fading regions. Additionally, continuous re-estimation using rotated pilot tones may allow for improved (e.g., more accurate) tracking of channel variations and CFO/sampling frequency offset (SFO), compared to fixed pilot distribution. Further, the distributed pilot tone mapping techniques described herein may reduce the predictability of interference and provide better resilience against targeted interference or jamming, compared to fixed pilot distribution.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”. As used herein, the terms “carrier,” “subcarrier,” “frequency channel,” “channel unit,” “channel,” and “tone” may be used interchangeably to refer to a frequency unit (or unit of frequency).

Note, the techniques described herein for mapping pilot tones to dRUs may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or a client station (STA).

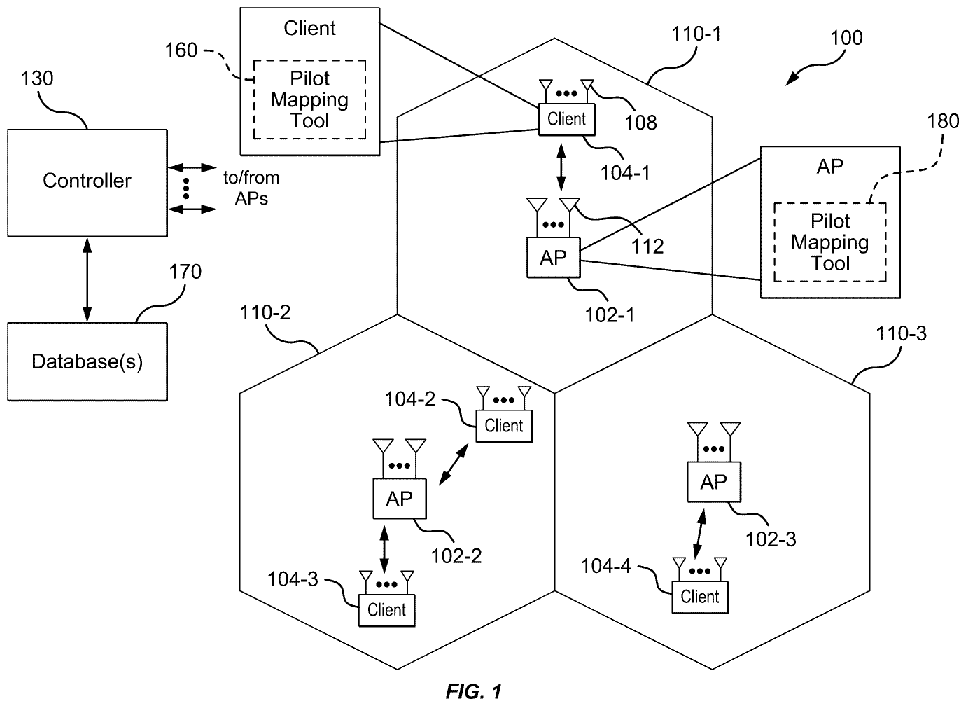

FIG. 1 illustrates an example system 100 in which one or more techniques described herein can be implemented, according to certain embodiments. As shown, the system 100 includes, without limitation, one or more APs (e.g., AP 102-1, AP 102-2, and AP 102-3), one or more client STAs (e.g., client STA 104-1, client STA 104-2, client STA 104-3, and client STA 104-4), a controller 130, and one or more databases 170.

An AP is generally a fixed station that communicates with client STA(s) and may be referred to as a base station, wireless device, or some other terminology. A client STA may be fixed or mobile and also may be referred to as a mobile STA, a client, a STA, a wireless device, or some other terminology. Note that while a certain number of APs and client STAs are depicted, the system 100 may include any number of APs and client STAs.

As used herein, an AP along with the STAs associated with the AP (e.g., within the coverage area (or cell) of the AP) may be referred to as a basic service set (BSS). Here, AP 102-1 is the serving AP for client STA 104-1, AP 102-2 is the serving AP for client STAs 104-2 and 104-3, and AP 102-3 is the serving AP for client STA 104-4. The AP 102-1, AP 102-2, and AP 102-3 are neighboring (peer) APs. The APs 102 may communicate with one or more client STAs 104 on the downlink and uplink. The downlink (e.g., forward link) is the communication link from the AP 102 to the client STA(s) 104, and the uplink (e.g., reverse link) is the communication link from the client STA(s) 104 to the AP 102. In some cases, a client STA may also communicate peer-to-peer with another client STA.

As shown in FIG. 1, each client STA 104 includes one or more radios 108. The client STA 104 can use one or more of the radios 108 to form links with an AP 102. As also shown, each AP 102 includes one or more radios 112 that the AP 102 can use to form links with one or more client STAs 104 and/or one or more APs 102. In general, the AP(s) 102 and the client STA(s) 104 may form any suitable number of links for communication using any suitable frequencies and using any suitable communication protocols. In some instances, a client STA 104 may form multiple links with a single AP 102.

In certain embodiments, the APs 102 may be controlled or managed at least partially by the controller 130. Here, the controller 130 couples to and provides coordination and control for the APs 102 1-3. For example, the controller 130 may handle adjustments to RF power, channels, authentication, and security for the APs. The controller 130 may also coordinate the links formed by the client STA(s) 104 with the APs 102. The controller 130 and APs 102 may utilize a same control plane protocol.

The operations of the controller 130 may be implemented by any device or system, and may be combined or distributed across any number of systems. For example, the controller 130 may be a WLAN controller for the deployment of APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. The database(s) 170 are representative of storage systems that may include, without limitation, pilot mapping patterns, radio resource configurations, and radio resource management (RRM) information, among other information.

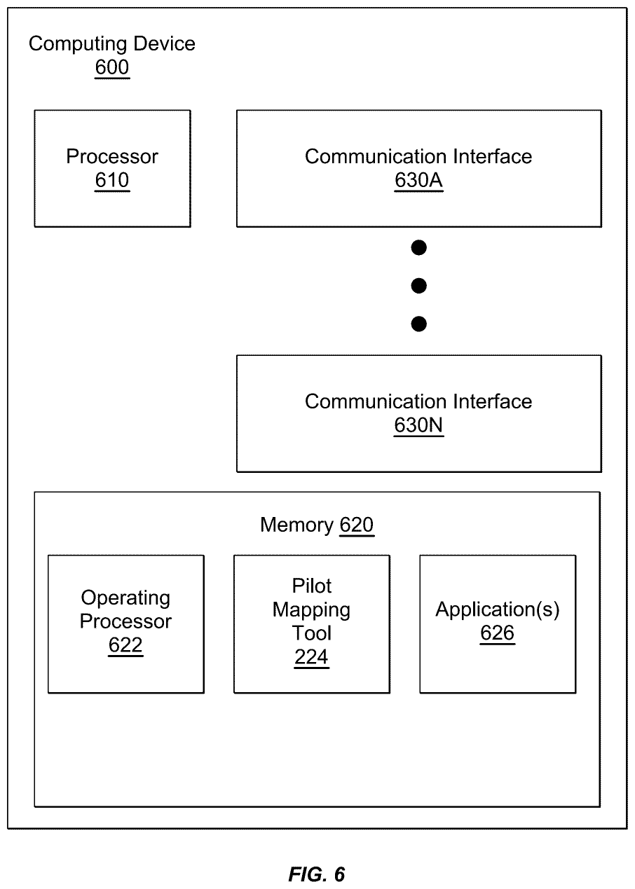

In certain embodiments, the AP 102 and/or client STA 104 may be configured to map pilot tones to dRUs using techniques described herein. As shown, the AP 102 includes a mapping tool 180, and the client STA 104 includes a mapping tool 160. The mapping tools 160 and 180 are configured to perform one or more techniques described herein and are described in greater detail below. Example hardware that may be included in an AP 102, a controller 130, or a client STA 104 is discussed in greater detail with regard to FIG. 6.

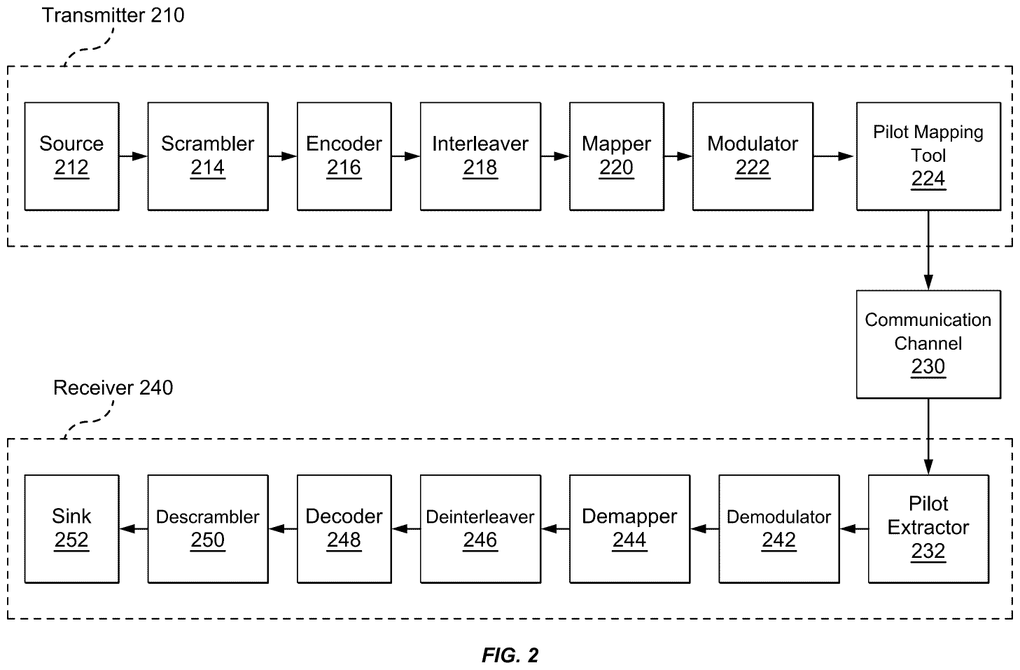

FIG. 2 is a block diagram illustrating at least a portion of a transmitter 210 and receiver 240, according to certain embodiments. The transmitter 210 includes, without limitation, a data source 212, a scrambler 214, an encoder 216, an interleaver 218, a mapper 220, a modulator 222, and a pilot mapping tool 224. In certain embodiments, the pilot mapping tool 224 is representative of the pilot mapping tool 160 or the pilot mapping tool 180 illustrated in FIG. 1. The receiver 240 includes, without limitation, a pilot extractor 232, a demodulator 242, a demapper 244, a deinterleaver 246, a decoder 248, a descrambler 250, and a data sink 252. In certain embodiments, the transmitter 210 and receiver 240 may be included within a transceiver of a computing device, such as client STA 104 or AP 102.

As shown, the scrambler 214 may receive data (e.g., bit stream) from a data source 212 and process the data to generate scrambled data. The encoder 216 (e.g., forward error corrector (FEC) encoder) encodes the scrambled data to generate encoded data. The interleaver 218 interleaves bits of the encoded data (e.g., changes the order of the bits) to reduce noise at the receiver 240. The mapper 220 symbol maps the interleaved data to obtain data symbols. For example, the mapper 220 may map interleaved sequences of bits to constellation points corresponding to different subcarriers of a symbol (e.g., orthogonal frequency division multiplexing (OFDM) symbol, single-carrier frequency division multiplexing (SC-FDM) symbol, etc.). The modulator 222 processes the data symbol(s) to obtain an output symbols. The pilot mapping tool 224 insert pilots within the output symbols using one or more techniques described herein. Although not shown, the transmitter 210 may further process the output symbols (with included pilots) (e.g., convert to analog, amplify, filter, and upconvert) to obtain an output signal (e.g., downlink signal or uplink signal). The output signal may be transmitted across a communication channel 230 via one or more antennas (not shown in FIG. 2).

At the receiver 240, antenna(s) (not shown in FIG. 2) may receive input signals and provide the received signals to the demodulator 242. The demodulator 242 may condition (e.g., filter, amplify, downconvert, and digitize) the received signal to obtain input samples. The demodulator 242 may also process the input samples to obtain received symbols. The demapper 244 performs constellation demapping on the received symbols to obtain demapped data. The deinterleaver 246 deinterleaves the demapped data. The decoder 248 decodes the deinterleaved data, and the descrambler 250 descrambles the decoded data before providing the descrambled data to a data sink 252.

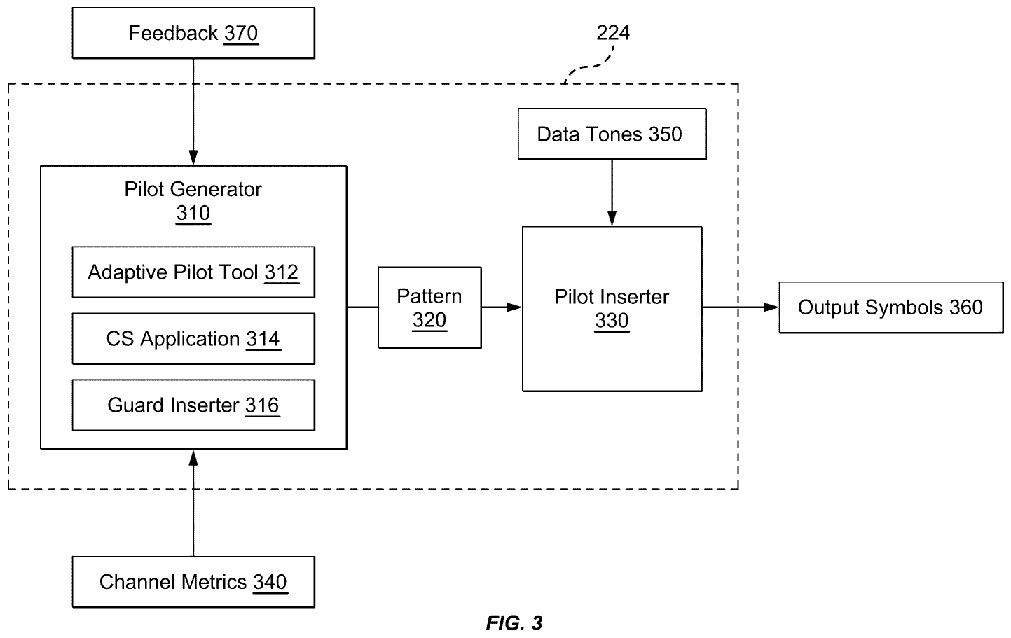

FIG. 3 further illustrates the pilot mapping tool 224 illustrated in FIG. 2, according to certain embodiments. As shown, the pilot mapping tool 224 includes, without limitation, a pilot generator 310 and a pilot inserter 330, each of which may include hardware, software, or combinations thereof. In certain embodiments, the pilot generator 310 includes an adaptive pilot tool 312, a compressive sensing (CS) application 314, and/or a guard inserter 316.

The pilot generator 310 may generate a pilot tone mapping pattern 320 for distributing (or mapping) pilot tones to dRUs across time and frequency, and provide the pattern 320 to the pilot inserter 330. The pilot tone mapping pattern 320 may include one or more pilot tones along with an indication of where each pilot tone is to be placed within the dRU. The pilot inserter 330 may insert one or more pilot tones among the data tones 350 of a dRU according to the pattern 320. The pilot inserter 330 may provide output symbols 360 including data tones 350 and pilot tones.

In certain embodiments, the pilot generator 310 may use an adaptive pilot placement to map pilot tones to dRUs, e.g., via the adaptive pilot tool 312. In some examples, the adaptive pilot tool 312 may determine the optimal pilot placement based on one or more channel metrics, such as received signal strength indication (RSSI), signal-to-interference-plus-noise ratio (SINR), a signal-to-noise ratio (SNR), and bit-error rate (BER), among others. The adaptive pilot tool 312 may generate the pilot tone mapping pattern 320 that includes an indication of the optimal pilot placement.

In some examples, the adaptive pilot tool 312 may receive feedback 370 including an indication of the optimal pilot placement from another computing device, such as an AP 102. For example, the AP 102 may be able to feedback the optimal pilot placement to a client STA 104 in a trigger frame, e.g., in trigger-based (TB) uplink (UL) orthogonal frequency division multiple access (OFDMA) (UL-OFDMA). In such examples, the AP may adaptively adjust the optimal pilot placement for each uplink OFDMA transmission for each respective client STA 104 based on the respective estimated channel in the previous transmission. With this technique, the AP may be able to dynamically disable or enable the pilot tone rotation mechanism described herein depending on the environment (e.g., channel quality). The adaptive pilot tool 312 may generate the pilot tone mapping pattern 320 that includes an indication of the optimal pilot placement.

In certain embodiments, the pilot generator 310 may use a CS application 314 to map pilot tones to dRUs. As noted, the pilot tones in dRU may be sparsely and non-uniformly distributed across the frequency band. Traditional channel estimation techniques, such as interpolation, may struggle with such a distribution. In some cases, CS techniques can be used to recover the channel's state information between the sparse pilot tones using fewer measurements than traditional methods. CS can leverage the sparse nature of the channel's delay profile to reconstruct the channel's state in between the pilot tones. In certain embodiments, CS may provide a random placement of the pilot tones, which can be used to achieve a more accurate channel estimation. Accordingly, CS techniques may be distinct from conventional methods that often rely on uniform pilot placements.

In certain embodiments, the pilot generator 310 may use an adaptive guard insertion technique to map pilot tones to dRUs, e.g., via the guard inserter 316. In certain examples, depending on the level of misalignment and interference from other users, the guard inserter 316 may adaptively introduce guards or adjust the dRU structure in real-time. This dynamic adjustment by the guard inserter 316 can help mitigate intercarrier interference (ICI) introduced due to misalignment.

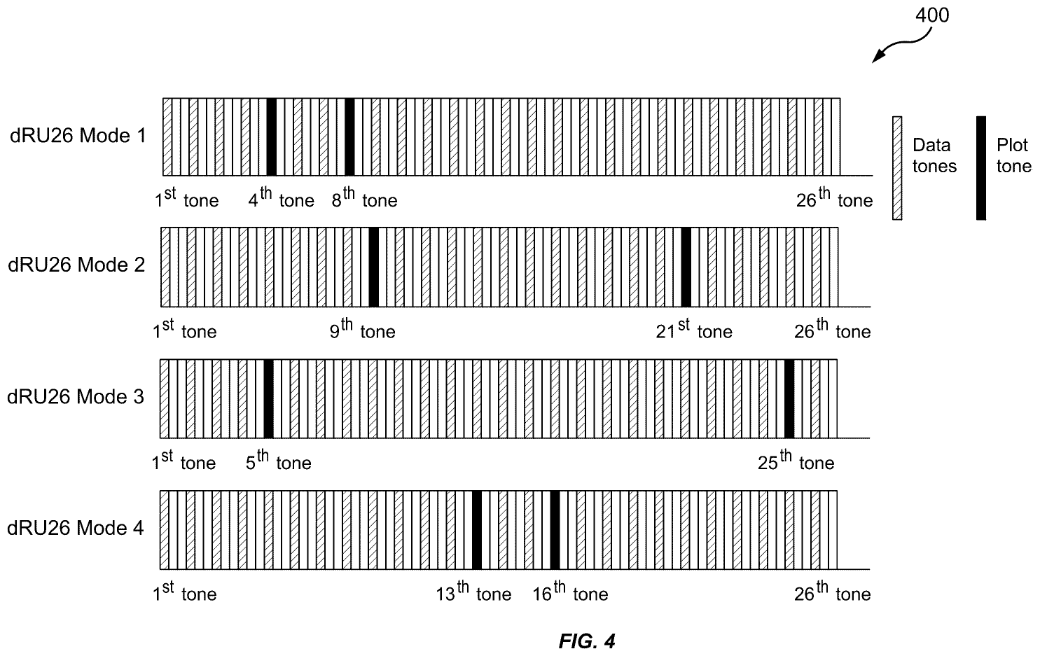

FIG. 4 depicts an example distributed mapping 400 of pilot tones to dRUs, according to certain embodiments. As shown, the distributed mapping 400 includes four dRU modes 1-4, each with a different distribution of pilot tones among data tones. For example, in dRU mode 1, the pilot tones are placed at the 4^{th} and 8^{th} tones among the data tones. In dRU mode 2, the pilot tones are placed at the 9^{th} and 21^{st} tones among the data tones. In dRU mode 3, the pilot tones are placed at the 5^{th} and 25^{th} tones among the data tones. In dRU mode 4, the pilot tones are placed at the 13^{th} and 16^{th} tones among the data tones.

Referring back to FIG. 3, in certain embodiments, the pilot pattern 320 may include an indication of one of the dRU modes, such as dRU modes 1-4 illustrated in FIG. 4. For example, the pilot generator 310 may adaptively change the indication of the dRU mode that is included within the pilot pattern 320 over time, such that pilot tones are mapped to dRUs across time and frequency. For example, different data symbols may include different allocations of pilot tones among the data tones within the data symbols.

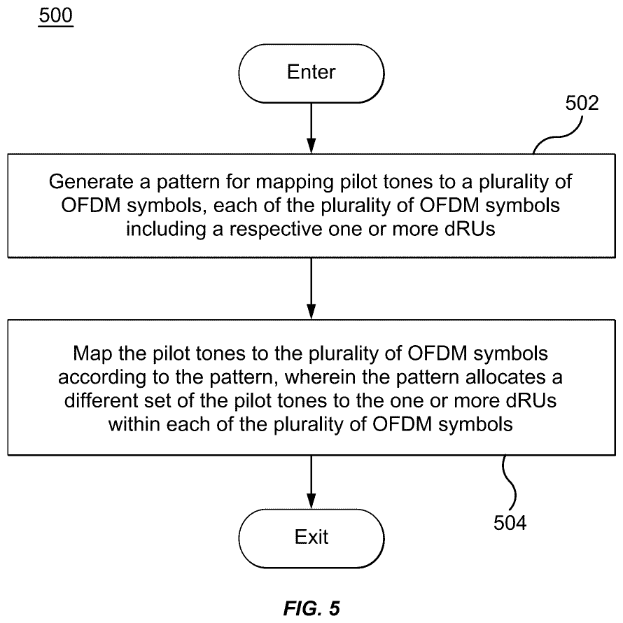

FIG. 5 is a flowchart of a method 500 for wireless communications, according to one embodiment. The method 500 may be performed by a computing device, such as an AP 102 or client STA 104, as illustrative examples. In certain embodiments, the method 500 may be performed to map pilot tones to dRUs.

Method 500 enters at block 502, where the computing device generates a pattern for mapping pilot tones to a plurality of orthogonal frequency division multiplexing (OFDM) symbols. Each of the plurality of OFDM symbols includes a respective one or more dRUs.

At block 504, the computing device maps the pilot tones to the plurality of OFDM symbols according to the pattern. The pattern allocates a different set of the pilot tones to the one or more dRUs within each of the plurality of OFDM symbols.

In certain embodiments, mapping the pilot tones to the plurality of OFDM symbols includes: (i) allocating a first set of the pilot tones to a first set of frequency locations within a dRU of a first OFDM symbol of the plurality of OFDM symbols; and (ii) allocating a second set of the pilot tones to a second set of frequency locations within a dRU of a second OFDM symbol of the plurality of OFDM symbols.

In certain embodiments, the pilot tones are mapped to the plurality of OFDM symbols, such that each OFDM symbol includes a different set of the pilot tones across time and frequency.

In certain embodiments, the method 500 further includes receiving an indication of the pattern from another computing device, wherein the pattern is generated after receiving the indication of the pattern. In certain examples, the indication is received in a trigger frame for an UL-OFDMA transmission.

In certain embodiments, the method 500 further includes determining one or more metrics associated with a communication link between the computing device and another computing device, wherein the pattern is generated based in part on the one or more metrics. The one or more metrics may include at least one of (i) an RSSI, (ii) an SNR, or (iii) a BER.

In certain embodiments, the pattern is generated via a CS application. In certain examples, the pattern generated via the CS application may include a respective random placement for each different set of pilot tones within the respective OFDM symbol.

In certain embodiments, mapping the pilot tones to the plurality of OFDM symbols includes inserting a respective one or more guard tones into the one or more dRUs within each of the plurality of OFDM symbols.

FIG. 6 illustrates an example computing device 600, according to one embodiment. The computing device 600 can be configured to perform one or more techniques described herein for mapping pilot tones to dRUs. For example, the computing device 600 can perform method 500 and any other techniques (or combination of techniques) described herein. The computing device 600 may be representative of a controller (e.g., controller 130), a network entity (e.g., an AP, such as AP 102), or a wireless device (e.g., client STA 104). The computing device 600 includes, without limitation, a processor 610, a memory 620, and one or more communication interfaces 630a-n (generally, communication interface 630). In one example, the communication interface 630 includes a radio.

The processor 610 may be any processing element capable of performing the functions described herein. The processor 610 represents a single processor, multiple processors, a processor with multiple cores, and combinations thereof. The communication interfaces 630 (e.g., radios) facilitate communications between the computing device 600 and other devices. The communications interfaces 630 are representative of wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes pilot mapping tool 224 and one or more application(s) 626.

The computing device 600 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### EXAMPLE CLAUSES

Implementation examples are described in the following numbered clauses:

Clause 1: A method for wireless communications performed by a computing device, comprising: generating a pattern for mapping pilot tones to a plurality of orthogonal frequency division multiplexing (OFDM) symbols, each of the plurality of OFDM symbols comprising a respective one or more distributed-tone resource units (dRUs); and mapping the pilot tones to the plurality of OFDM symbols according to the pattern, wherein the pattern allocates a different set of the pilot tones to the one or more dRUs within each of the plurality of OFDM symbols.

Clause 2: The method of Clause 1, wherein mapping the pilot tones to the plurality of OFDM symbols comprises: allocating a first set of the pilot tones to a first set of frequency locations within a dRU of a first OFDM symbol of the plurality of OFDM symbols; and allocating a second set of the pilot tones to a second set of frequency locations within a dRU of a second OFDM symbol of the plurality of OFDM symbols.

Clause 3: The method according to any of Clauses 1-2, wherein the pilot tones are mapped to the plurality of OFDM symbols, such that each OFDM symbol includes a different set of the pilot tones across time and frequency.

Clause 4: The method according to any of Clauses 1-3, further comprising receiving an indication of the pattern from another computing device, wherein the pattern is generated after receiving the indication of the pattern.

Clause 5: The method of Clause 4, wherein receiving the indication comprises receiving a trigger frame for an uplink orthogonal frequency division multiple access (UL-OFDMA) transmission, the trigger frame comprising the indication.

Clause 6: The method according to any of Clauses 1-5, further comprising determining one or more metrics associated with a communication link between the computing device and another computing device, wherein the pattern is generated based in part on the one or more metrics.

Clause 7: The method of Clause 6, wherein the one or more metrics comprise at least one of (i) a received signal strength indication (RSSI), (ii) a signal-to-noise ratio (SNR), or (iii) a bit-error rate (BER).

Clause 8: The method according to any of Clauses 1-7, wherein the pattern is generated via a compressive sensing (CS) application.

Clause 9: The method according to any of Clauses 1-8, wherein the pattern comprises a respective random placement for each different set of pilot tones within the respective OFDM symbol.

Clause 10: The method according to any of Clauses 1-9, wherein mapping the pilot tones to the plurality of OFDM symbols comprises inserting a respective one or more guard tones into the one or more dRUs within each of the plurality of OFDM symbols.

Clause 11: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-10.

Clause 12: A non-transitory computer-readable medium comprising computer-executable code, which when executed by one or more processors of a computing device perform a method in accordance with any of Clauses 1-10.

Clause 13: An apparatus comprising means for performing a method in accordance with any of Clauses 1-10.

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for wireless communications performed by a computing device, comprising:
generating a pattern for mapping pilot tones to a plurality of orthogonal frequency division multiplexing (OFDM) symbols, each of the plurality of OFDM symbols comprising a respective one or more distributed-tone resource units (dRUs); and
mapping the pilot tones to the plurality of OFDM symbols according to the pattern, wherein the pattern allocates a different set of the pilot tones to the one or more dRUs within each of the plurality of OFDM symbols.

2. The method of claim 1, wherein mapping the pilot tones to the plurality of OFDM symbols comprises:
allocating a first set of the pilot tones to a first set of frequency locations within a dRU of a first OFDM symbol of the plurality of OFDM symbols; and
allocating a second set of the pilot tones to a second set of frequency locations within a dRU of a second OFDM symbol of the plurality of OFDM symbols.

3. The method of claim 1, wherein the pilot tones are mapped to the plurality of OFDM symbols, such that each OFDM symbol includes a different set of the pilot tones across time and frequency.

4. The method of claim 1, further comprising receiving an indication of the pattern from another computing device, wherein the pattern is generated after receiving the indication of the pattern.

5. The method of claim 4, wherein receiving the indication comprises receiving a trigger frame for an uplink orthogonal frequency division multiple access (UL-OFDMA) transmission, the trigger frame comprising the indication.

6. The method of claim 1, further comprising determining one or more metrics associated with a communication link between the computing device and another computing device, wherein the pattern is generated based in part on the one or more metrics.

7. The method of claim 6, wherein the one or more metrics comprise at least one of (i) a received signal strength indication (RSSI), (ii) a signal-to-noise ratio (SNR), or (iii) a bit-error rate (BER).

8. The method of claim 1, wherein the pattern is generated via a compressive sensing (CS) application.

9. The method of claim 8, wherein the pattern comprises a respective random placement for each different set of pilot tones within the respective OFDM symbol.

10. The method of claim 1, wherein mapping the pilot tones to the plurality of OFDM symbols comprises inserting a respective one or more guard tones into the one or more dRUs within each of the plurality of OFDM symbols.

11. A computing device comprising:
one or more memories collectively storing instructions; and
one or more processors communicatively coupled to the one or more memories, the one or more processors being individually or collectively configured to execute the instructions to cause the computing device to perform an operation comprising:
generating a pattern for mapping pilot tones to a plurality of orthogonal frequency division multiplexing (OFDM) symbols, each of the plurality of OFDM symbols comprising a respective one or more distributed-tone resource units (dRUs); and
mapping the pilot tones to the plurality of OFDM symbols according to the pattern, wherein the pattern allocates a different set of the pilot tones to the one or more dRUs within each of the plurality of OFDM symbols.

12. The computing device of claim 11, wherein mapping the pilot tones to the plurality of OFDM symbols comprises:
allocating a first set of the pilot tones to a first set of frequency locations within a dRU of a first OFDM symbol of the plurality of OFDM symbols; and
allocating a second set of the pilot tones to a second set of frequency locations within a dRU of a second OFDM symbol of the plurality of OFDM symbols.

13. The computing device of claim 11, wherein the pilot tones are mapped to the plurality of OFDM symbols, such that each OFDM symbol includes a different set of the pilot tones across time and frequency.

14. The computing device of claim 11, the operation further comprising receiving an indication of the pattern from another computing device, wherein the pattern is generated after receiving the indication of the pattern.

15. The computing device of claim 14, wherein receiving the indication comprises receiving a trigger frame for an uplink orthogonal frequency division multiple access (UL-OFDMA) transmission, the trigger frame comprising the indication.

16. The computing device of claim 11, the operation further comprising determining one or more metrics associated with a communication link between the computing device and another computing device, wherein the pattern is generated based in part on the one or more metrics.

17. The computing device of claim 11, wherein the pattern is generated via a compressive sensing (CS) application.

18. The computing device of claim 17, wherein the pattern comprises a respective random placement for each different set of pilot tones within the respective OFDM symbol.

19. The computing device of claim 11, wherein mapping the pilot tones to the plurality of OFDM symbols comprises inserting a respective one or more guard tones into the one or more dRUs within each of the plurality of OFDM symbols.

20. A non-transitory computer-readable medium comprising computer-executable code, which when executed by one or more processors of a computing device perform an operation comprising:
generating a pattern for mapping pilot tones to a plurality of orthogonal frequency division multiplexing (OFDM) symbols, each of the plurality of OFDM symbols comprising a respective one or more distributed-tone resource units (dRUs); and
mapping the pilot tones to the plurality of OFDM symbols according to the pattern, wherein the pattern allocates a different set of the pilot tones to the one or more dRUs within each of the plurality of OFDM symbols.
